(19) United States
(12) Patent Application Publication
(10) Pub. No.: US 2012/0050456 A1
(43) Pub. Date: Mar. 1, 2012

(54) SYSTEM AND METHOD FOR PRODUCING A PERFORMANCE VIA VIDEO CONFERENCING IN A NETWORK ENVIRONMENT

(75) Inventors: Michael A. Arnao, Collegeville, PA (US); J. William Mauchly, Berwyn, PA (US)

(73) Assignee: Cisco Technology, Inc.

(21) Appl. No.: 12/870,687

(22) Filed: Aug. 27, 2010

(51) Int. Cl. H04N 7/15

(52) U.S. Cl. 348/14.12; 348/E07.083

(57) ABSTRACT

A method is provided in one example and includes receiving a first audio signal and a first video signal from a first network element. The method also includes adding a second audio signal to the first audio signal to generate a combined audio signal, where a second video signal is combined with the first video signal to generate a combined video signal. The first network element and the second network element reside in different geographic locations. The combined audio signal and the combined video signal is then transmitted to a next destination.

### TECHNICAL FIELD

This disclosure relates in general to the field of video and, more particularly, to producing a performance via video conferencing in a network environment.

### BACKGROUND

It is difficult for performers at different geographic locations to have their collaborative works synchronized. For example, video conferencing endpoints are unable to synchronize performances by individuals due to codec limitations, and network delays, which can total (on the order of) hundreds of milliseconds. However, good musicians (by way of example) can often perceive as little as a 5 ms difference between the arrival time of two different sounds. In typical multipoint audio or video conferencing, media streams are sent to a centralized server, which then redistributes the streams to all participants. The minimum latency produced by such a scheme is too great for effective musical synchronization. Hence, coordinating audio and/or video data in performance environments presents a significant challenge to system designers, network operators, and device manufacturers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram illustrating a system for producing a performance via video conferencing in accordance with one embodiment of the present disclosure;

FIG. 2 is a simplified schematic diagram illustrating a flow between locations connected via a video conference system in accordance with one embodiment of the present disclosure;

FIG. 3 is a simplified schematic diagram illustrating a flow associated with a single audio mixing module of a video conference system in accordance with one embodiment of the present disclosure;

FIG. 4 is a simplified schematic diagram illustrating an example aggregation of audio tracks over time in a video conference system in accordance with one embodiment of the present disclosure; and

FIG. 5 is a simplified flow diagram illustrating potential operations associated with the system.

### DETAILED DESCRIPTION OF EXAMPLE EMBODIMENTS OVERVIEW

A method is provided in one example and includes receiving a first audio signal and a first video signal from a first network element. The method also includes adding a second audio signal to the first audio signal to generate a combined audio signal, where a second video signal is combined with the first video signal to generate a combined video signal. The first network element and the second network element reside in different geographic locations. The combined audio signal and the combined video signal is then transmitted to a next destination.

In more specific implementations, the method can also include recording the combined audio signal and the combined video signal at the next destination. In other examples, the method includes transmitting the combined audio signal and the combined video signal to an audience location; rendering the combined audio signal and the combined video signal at the audience location; and transmitting audience audio signals and audience video signals to locations associated with the first network element and the second network element.

The next destination can be associated with a performer that generates a third audio signal to be added to the combined audio signal from the first network element and the second network element. A reference audio track can be played by the second network element and is included in the combined audio signal. The combined audio signal can reflect a synchronization of the first audio signal and the second audio signal, where the combined audio signal can be rendered to an end user that generated the second audio signal. The second network element detects a delay associated with the audio data and compensates for the delay in conjunction with generating the combined audio signal.

### Example Embodiments

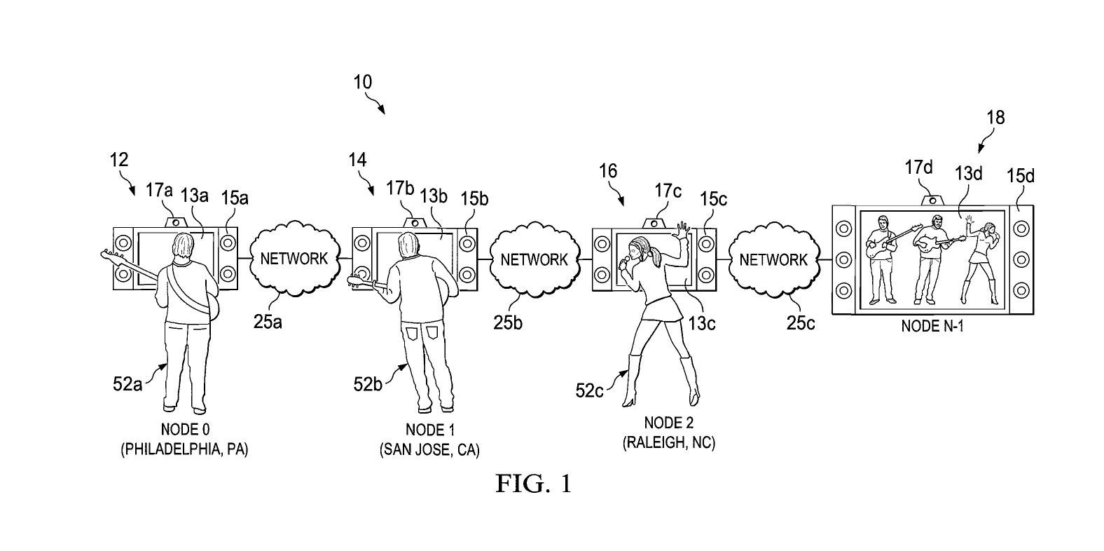

Turning to FIG. 1, FIG. 1 is a simplified schematic diagram illustrating a system 10 for producing a performance via video conferencing in accordance with one embodiment of the present disclosure. In a particular example, system 10 is representative of an architecture for producing a musical performance TelePresence technology (i.e., a type of video conferencing) in which some or all of the performers, producers, engineers, etc., can be located at different geographic locations. System 10 includes a series of nodes: node 0, 12, node 1, 14, node 2, 16, and node N-1, 18. In one particular example, nodes 12, 14, 16, and 18 are representative of a videoconferencing endpoint, which can have video and/or audio capabilities as described below. In other implementations, nodes 12, 14, 16, and 18 are simply audio receiving devices with limited, or no, video capabilities. FIG. 1 also includes a plurality of networks 25a-c, which provide connectivity to a plurality of performers 52a-c that are geographically separated: residing in Philadelphia, Pa., San Jose, Calif., and Raleigh N.C., respectively in this example.

Each node 12, 14, 16, 18 in this embodiment includes a monitor 13a, 13b, 13c, 13d, a set of speakers 15a, 15b, 15c, 15d and an integrated camera/microphone 17a, 17b, 17c, 17d. Monitors 13a-13c can be mounted based on particular preferences to enable performers 52a, 52b, 52c at each respective location to see their own monitor while performing. For example, a standing guitar playing performer 52a may want the monitor mounted higher than would a performer sitting and playing the drums.

Operationally, and in the context of a performance, nodes 12, 14, 16, and 18 can be connected in a daisy-chain configuration to create a serialized network. Ordering the nodes from 0 through N-1, node 12, would be the head (i.e., the starting point) of the chain, where node 18 is the tail or final location. In this particular embodiment, node 18 is also reflective of an audience location, which could ostensibly receive the end result of the collaboration amongst the musicians.

As the collaboration begins, performer 52a at node 0 can play to a monitor mix consisting of pre-recorded or synthesized reference tracks (heard through headphones or speakers 15a). This generates one or more live tracks (or signals), and the audio is transmitted to node 1 over network 25a. Subsequently, performer 52b at node 1 plays to a monitor mix consisting of a combination of the node 0 live track and the reference tracks: generating one or more live tracks, where the audio is transmitted to node 2 over network 25b. Similarly, performer 52c at node 2 sings to a monitor mix consisting of a combination of the node 0 and node 1 live tracks (and the reference tracks). This generates one or more live tracks and the audio is transmitted to node N-1 over a network 25c. The live and reference audio tracks at a given node can be synchronized, and the performers (at all but node 0) can hear the live contribution from at least one other node.

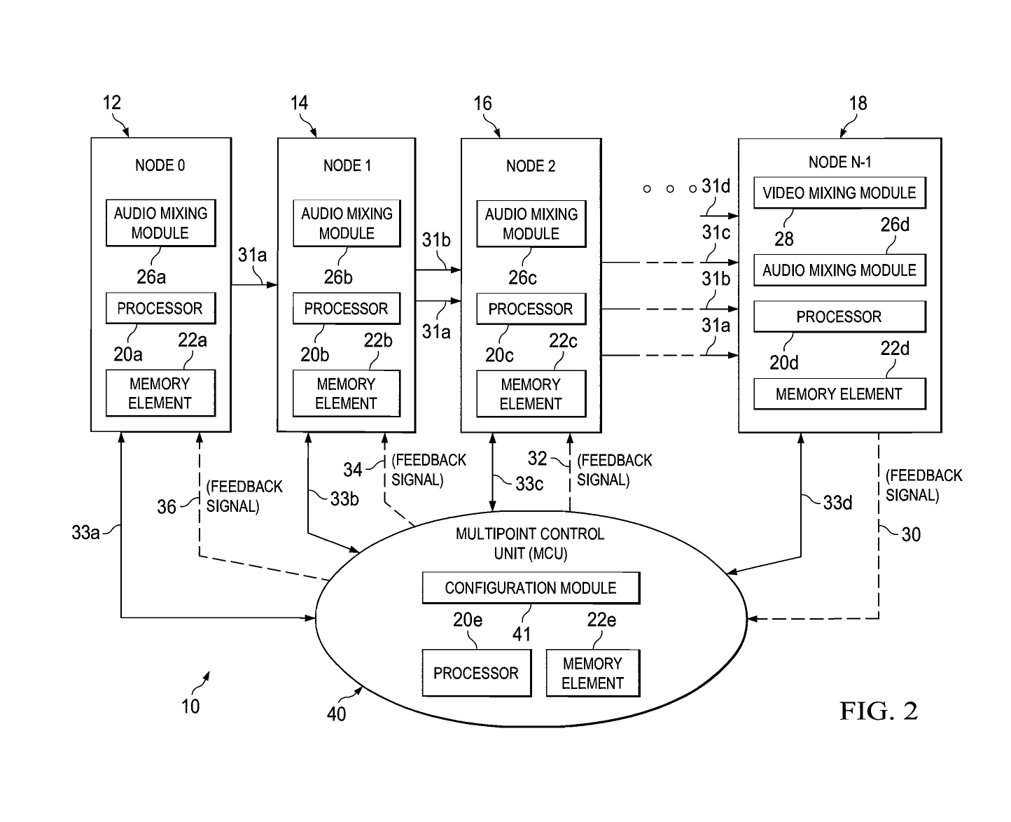

During a performance, audio from the performers flows in a single direction, from lower-numbered to higher-numbered nodes in the example of FIG. 1. Such an implementation ensures that no one hears audio that is delayed with respect to his own performance. The reference tracks may consist of a click track or a multi-track arrangement of the musical piece to be performed. While the audio signals are being gathered, video signals from nodes 0, 1, and 2 are also transmitted to node N-1. The audio and video signals are combined and synchronized at node N-1, where the resultant can be presented to the audience through monitor 13d and/or speakers 15d. When the audio and video is presented to the audience, the node N-1 camera/microphone can capture audio and video signals from the audience and, subsequently, transmit them over networks 25a-25c back to the first three nodes. The performers at the first three nodes can receive the presentation via each node's respective monitors 13a-13c and speakers 15a-15c, thereby providing viable (real-time) feedback on the performance. Before detailing more specific flows and features of system 10, a brief discussion of the infrastructure of FIG. 1 is provided. In addition, FIG. 2 is described concurrently with FIG. 1 in order to further outline particular implementations of nodes 12, 14, 16, and 18.

Monitors 13a-13d are screens at which video data can be rendered for one or more end users. Note that as used herein in this Specification, the term ‘monitor’ is meant to connote any element that is capable of delivering image data (inclusive of video information), text, sound, audiovisual data, etc. to an end user. This would necessarily be inclusive of any panel, plasma element, television, display, computer interface, screen, TelePresence devices (inclusive of TelePresence boards, panels, screens, surfaces, etc.) or any other suitable element that is capable of delivering/rendering/projecting such information.

Speakers 15a-15d and cameras/microphones 17a-17d are generally mounted around respective monitors 13a-13d. Cameras/microphones 17a-17d can include wireless cameras, high-definition cameras, or any other suitable camera device configured to capture image data. Similarly, any suitable audio reception mechanism can be provided to capture audio data at each individual node. In terms of their physical deployment, in one particular implementation, cameras/microphones 17a-17c are digital cameras, which are mounted on the top (and at the center of) monitors 13a-13c. One camera/microphone can be mounted to each display. Other camera/microphone arrangements and camera/microphone positioning is certainly within the broad scope of the present disclosure.

Each node 12, 14, 16, and 18 may interact with (or be inclusive of) devices used to initiate a communication for a video session, such as a switch, a console, a proprietary endpoint, a microphone, a dial pad, a bridge, a telephone, a smartphone (e.g., Google Droid, iPhone, etc.), an iPad, a computer, or any other device, component, element, or object capable of initiating video, voice, audio, media, or data exchanges within system 10. Each node 12, 14, 16, and 18 can also be configured to include a receiving module, a transmitting module, a processor, a memory, a network interface, a call initiation and acceptance facility such as a dial pad, one or more speakers, one or more displays, etc. Any one or more of these items may be consolidated, combined, or eliminated entirely, or varied considerably and those modifications may be made based on particular communication needs.

Note that in one example, each node 12, 14, 16, and 18 can have internal structures (e.g., a processor, a memory element, etc.) to facilitate the operations described herein. In other embodiments, these audio and/or video features may be provided externally to these elements or included in some other proprietary device to achieve their intended functionality. In still other embodiments, each node 12, 14, 16, and 18 may include any suitable algorithms, hardware, software, components, modules, interfaces, or objects that facilitate the operations thereof.

Networks 25a-25c represent a series of points or nodes of interconnected communication paths for receiving and transmitting packets of information that propagate through system 10. Networks 25a-25c offer a communicative interface between any of the nodes of FIG. 1, and may be any local area network (LAN), wireless local area network (WLAN), metropolitan area network (MAN), wide area network (WAN), virtual private network (VPN), Intranet, Extranet, or any other appropriate architecture or system that facilitates communications in a network environment. Note that in using networks 25a-25c, system 10 may include a configuration capable of transmission control protocol/internet protocol (TCP/IP) communications for the transmission and/or reception of packets in a network. System 10 may also operate in conjunction with a user datagram protocol/IP (UDP/IP) or any other suitable protocol, where appropriate and based on particular needs.

Turning to FIG. 2, FIG. 2 is a simplified schematic diagram illustrating the flow of data between locations connected via a video conference system in accordance with one embodiment of the present disclosure. In this particular implementation, each node 12, 14, 16, 18 includes an audio mixing module 26a-26d, a processor 20a-20d, and a memory element 22a-22d. In addition, node 18 includes a video mixing module 28, although it is imperative to note that any of nodes 12, 14, and 16 could have an appropriate video mixing module provisioned therein. In those examples, nodes 12, 14, and 16 would add accompanying video tracks in the same manner as described with reference to the audio data propagation discussed herein. FIG. 2 also illustrates a Multipoint Control Unit (MCU) 40 connected to each node, 12, 14, 16, 18. The connections between these elements can be facilitated by wired networks, wireless networks, or any other suitable communication pathway. MCU 40 can include a configuration module 41 along with a processor 20e and a memory element 22e.

Nodes 12, 14, 16, and 18 are configured to receive information from cameras/microphones 17a-17d via some connection that may attach to an integrated device (e.g., a set-top box, a proprietary box, etc.) that sits atop the monitor and that includes [or that may be part of] cameras/microphones 17a-17d. Nodes 12, 14, 16, and 18 may also be configured to control compression activities, or additional processing associated with data received from the cameras. Alternatively, an integrated device can perform this additional processing before image data is sent to its next intended destination. Nodes 12, 14, 16, and 18 can also be configured to store, aggregate, process, export, and/or otherwise maintain image data and logs in any appropriate format, where these activities can involve respective processors 20a-b, memory elements 22a-b, and audio mixing modules 26a-b. Nodes 12, 14, 16, and 18 and MCU 40 are network elements that facilitate data flows between endpoints and a given network. As used herein in this Specification, the term ‘network element’ is meant to encompass routers, switches, gateways, bridges, loadbalancers, firewalls, servers, processors, modules, or any other suitable device, component, element, or object operable to exchange information in a network environment. This includes proprietary elements equally.

Nodes 12, 14, 16, and 18 may interface with cameras/microphones 17a-17d through a wireless connection, or via one or more cables or wires that allow for the propagation of signals between these two elements. These devices can also receive signals from an intermediary device, a remote control, etc. and the signals may leverage infrared, Bluetooth, WiFi, electromagnetic waves generally, or any other suitable transmission protocol for communicating data (e.g., potentially over a network) from one element to another. Virtually any control path can be leveraged in order to deliver information between nodes 12, 14, 16, and 18 and cameras/microphones 17a-17d. Transmissions between these two sets of devices can be bidirectional in certain embodiments such that the devices can interact with each other (e.g., dynamically, real-time, etc.). This would allow the devices to acknowledge transmissions from each other and offer feedback, where appropriate. Any of these devices can be consolidated with each other, or operate independently based on particular configuration needs. For example, a single box may encompass audio and video reception capabilities (e.g., a set-top box that includes the camera and microphone components for capturing video and audio data respectively). In one embodiment, node 18 is shown as just the audience location; however, other embodiments also could be utilized. For example, there could be a performer at node 18, and the audience would be able to interact with this performer face to face while interacting with other performers via the video conference setup.

In operational terms, at node 12 a reference track can be played and a live signal can be captured and synchronized with the reference track in audio mixing module 26a. A set of audio signals 31a are uni-directionally transmitted to node 14 via the networks described above. At node 1, audio signal 31a can be synchronized and played, where an audio signal 31b is generated. Audio signals 31a and 31b are then in turn uni-directionally transmitted to node 16. At node 16, audio signals 31a and 31b are synchronized and played and an audio signal 31c is generated. Audio signals 31a, 31b, and 31c are then in turn uni-directionally transmitted to node 18. An audio signal 31d represents the variable number of nodes that could be included in this aggregation of signals by simply repeating this process.

Simultaneous to the capture of an audio signal, at each node 12, 14, 16, a video signal is also captured in this particular example. Each of these video signals is then transmitted to the final node (node 18) via a set of bidirectional pathways 33a-33d interconnecting each node through MCU 40. Alternatively, the video signals could be transmitted uni-directionally along with the audio data and, further, simply pass through each node before being delivered to node 18 (without being utilized at each individual intermediate node).

At node 18, audio signals 31a, 31b, and 31c and the video signals are synchronized via video mixing module 28 and audio mixing module 26d and, subsequently, combined into an integrated audio/video signal, which is transmitted to monitor 13d (e.g., presented to the audience at the location of node N-1). The terminating endpoints (e.g., node 18) could be a web server, a computer, a uniform resource locator (URL) (e.g., YouTube.com), or any other appropriate location that could facilitate presenting the aggregated information to one or more individuals. A set of feedback signals 30, 32, 34, and 36 are also provided between the nodes and MCU 40. In one particular implementation, MCU 40 transmits the feedback to each node via signaling pathways that could be wired or wireless.

MCU 40 can also control secondary audio signals between nodes 12, 14, and 16 in order to allow the performers to effectively communicate. Configuration module 41 can be configured to control the flow of data in a set of bidirectional pathways 33a-33d, which connect the nodes to MCU 40. When selected, configuration module 41 can readily operate in a multipoint mode, where it allows bidirectional communication between the nodes 12, 14, and 16. This configuration could facilitate a viable collaboration among the performers. Additionally, in this mode, recordings may be broadcast from the tail terminating node to the performers, where it could be systematically reviewed, enhanced, redistributed, or otherwise process in any suitable manner.

In cases where live video signals are routed and mixed, such aggregation activity can be conducted in a manner analogous to the live audio tracks. This could allow each performer to visually monitor performers at lower-numbered nodes, picking up visual cues that aid performance. This could also allow for a final video mix to be produced at the terminating node. The terminating node could also transmit a video mix back to one or more of the other nodes via MCU 40: allowing a visual monitoring of downstream performers by upstream performers, if synchronization of the video and audio monitoring signals is not a concern. At other times, freshly generated audio tracks can also be sent from the tail node back to the head node, to be replayed as a new set of reference tracks in subsequent performances. This could allow, for example, a gradual refinement of a multi-track recording.

In another alternative embodiment, MCU 40 acts as a separate control node. The control node can perform any number of the following functions: setting the node configuration; ordering the nodes from head to tail; providing an audio talkback connection to each node in a performance mode to allow verbal instructions to be given to performers; participating in multipoint conference to facilitate collaboration between, e.g., producer, engineer, and performers; transmitting reference tracks to a head node; receiving multi-track audio from the terminating node; receiving video from all nodes; producing an audio and video mix; recording audio and video; transmitting live audio and video to the audience; transmitting recorded audio and video to the performers.

In such an embodiment, bandwidth can be saved by avoiding multi-channel live-video transmissions from one node to the next during performances. In such an instance, each node would transmit full-bandwidth video to the control node, which appropriately delays each video channel as needed for synchronization with the audio tracks received from the terminating node. Each node may then transmit only a lower-bandwidth video signal to its downstream neighbor for visual monitoring.

The reference audio tracks can be synced to a particular timecode, which is subsequently recovered by each node. In one particular instance, the timecode is a Society of Motion Picture and Television Engineers (SMPTE) timecode, which reflects a set of cooperating standards to label individual frames of video or film with a timecode. Video can be generated with respect to this timecode: allowing audio/video synchronization to be performed without requiring the computation of inter-node delays. Such architectures can be used by broadcasting companies, entertainment venues, record companies, recording studios, musicians, music schools, etc. Potential uses can include staging live musical broadcasts; facilitating collaboration during the production of recordings among geographically diverse musicians, producers, and engineers; providing musical instruction, etc.

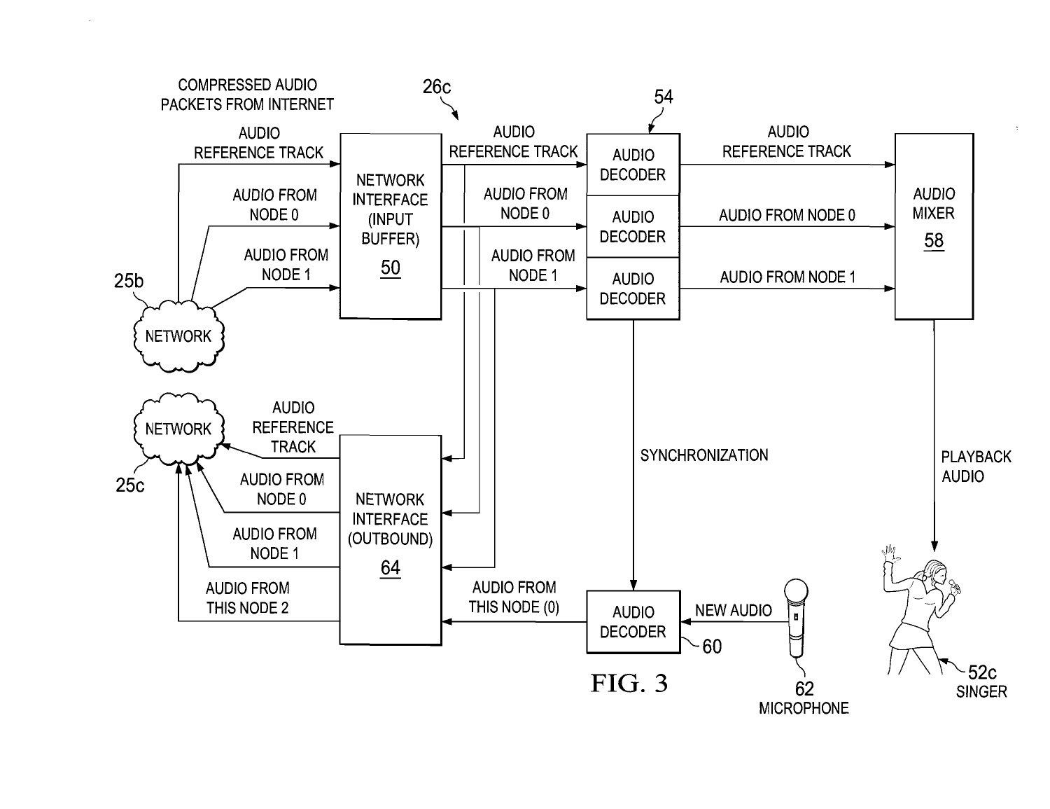

Referring now to FIG. 3, FIG. 3 is a simplified schematic diagram illustrating an example flow of data associated with a single audio mixing module 26c of a video conference system. In this particular implementation, audio mixing module 26c includes an input network interface 50 (e.g., reflective of an input buffer), a group of input audio decoders 54, and an audio mixer 58. FIG. 3 also includes an output audio decoder 60, a microphone 62, and an outbound network interface 64.

As described above, the audio reference track audio from node 0 and audio from node 1 can be uni-directionally transmitted to node 2 from node 1. These signals can be received into audio mixer 26c at input network interface 50, which is further described in detail below. After passing through input network interface 50, each signal can be split with a portion being routed directly to outbound network interface 64 and another portion being routed to one of the group of input audio decoders 54. The signal can be decoded and sent to audio mixer 58 to be played for performer 52c. Performer 52c inputs a new audio signal into microphone 62, where it is transmitted to output audio decoder 60. Output audio decoder 60 can receive synchronization data from input audio decoders 54 and, further, combine it with the new audio signal from microphone 62 to produce the audio signal of node 2. This audio signal is then sent through outbound network interface 64 along with the audio reference track audio from node 0 and audio from node 1. This can be uni-directionally transmitted to node 18 via network 25c, as is illustrated by FIG. 3.

Audio mixer 58 of audio mixing modules 26a, 26b, and 26c may be a multi-channel audio mixer manages the reference track, where the audio that is played at a particular node is a varying mix of tracks. Some of the tracks can be reference tracks, and the remaining tracks could be live-audio tracks. At each successive node, one or more live tracks are added. A multi-channel audio mixer at each node can allow tailoring of the monitor mix, as desired by the performers at that node. For example, if the only performer at node 0 is a drummer, the monitor mix for node 0 might consist of all reference tracks except the drum tracks. An additional multi-channel audio mixer 58 at node 18 can be used to produce a final mix, which consists of a combination of all tracks received, and the live-performance tracks generated at that node. The final mix can be transmitted to an audience or recorded. Additionally, the separate tracks can be suitably recorded and subsequently transmitted to an appropriate next destination, if so desired by the performers.

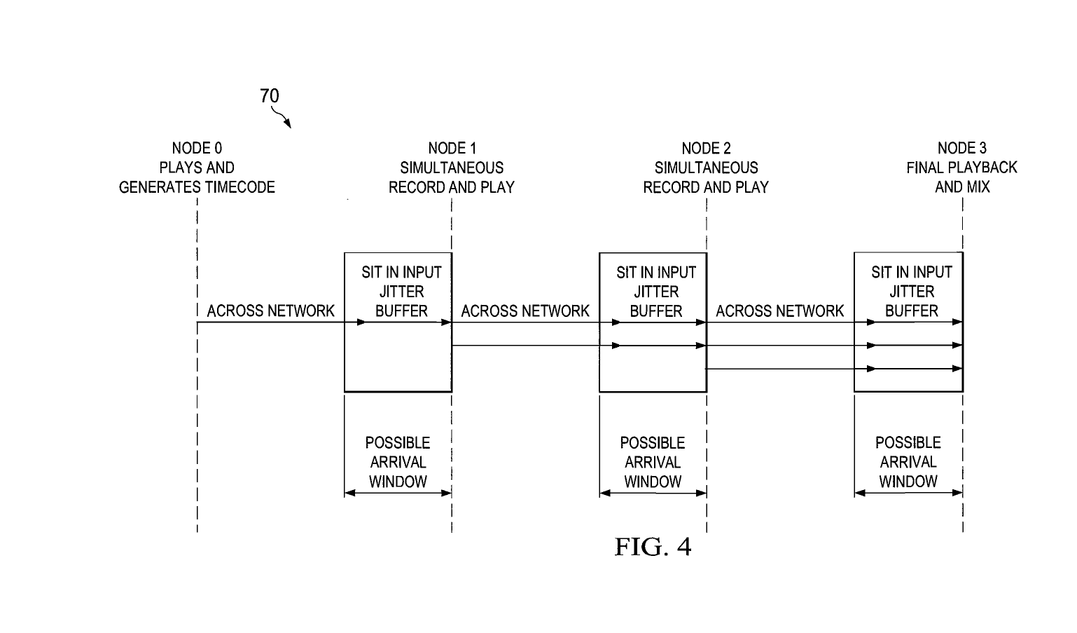

Referring to FIG. 4, FIG. 4 is a simplified schematic diagram 70 illustrating the aggregation of audio tracks sent to input network interfaces of a video conference system. A series of possible arrival windows are also depicted in FIG. 4. Additionally, audio and/or video can propagate from node to node across network connections. A particular timecode travels from node to node with increased delay caused by network latency and/or input jitter buffers at each node. As is illustrated, each node can reconstruct the audio playback sample clock and timecode, while monitoring the jitter buffer and adjusting the playback sample clock to avoid overrun or underrun. Each node can hear/capture the tracks associated with a particular timecode, including its own, at exactly the same time. Each node systematically adds its audio and/or video data, which gets combined with the existing audio and/or video data and sent to an appropriate next destination.

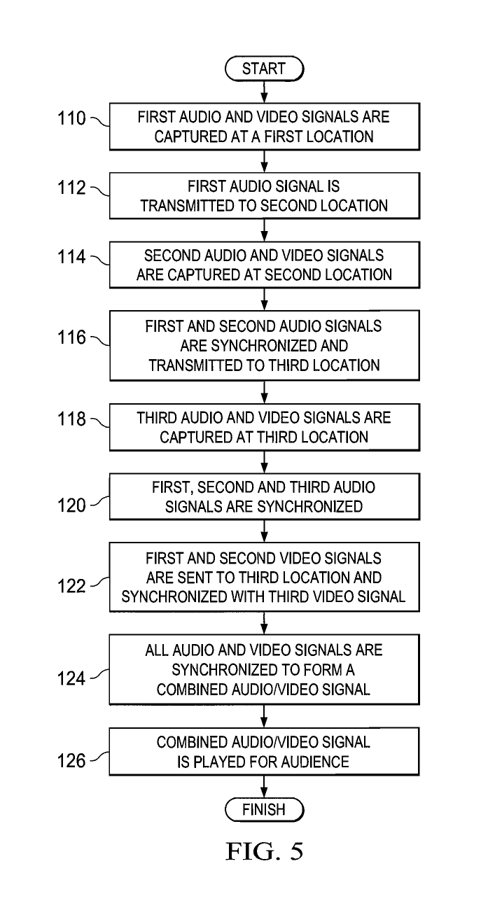

FIG. 5 is a simplified flow diagram illustrating one potential operation associated with the present disclosure. The flow may begin at step 110, where audio and video signals are captured at a first location. This can involve a first performer who may be generating any type of sound that can be combined with other tracks. At step 112, the first audio signal is transmitted to a second location, which can similarly involve a performer. Second audio and video signals are captured at step 114, and then the first and second audio signals are synchronized and transmitted to a third location at step 116. At this third location, third audio and video signals are captured, as shown in step 118. In step 120, the first, second, and third audio signals are also synchronized.

Step 122 involves transmitting the first and second video signals, from the first and second locations respectively, to the third location and, further, synchronizing the three video signals. In step 124, the audio and the video signals can be synchronized to form a combined audio/video signal. Finally, in step 126, this combined audio/video signal can be played for an audience, for the performers that generated the music, for any subset or combination of these individuals, or simply stored for later review.

Note that in certain example implementations, the audio and/or video mixing functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIG. 2] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

In one example implementation, nodes 12, 14, 16, and 18 can include software in order to achieve the synchronization of audio signals outlined herein. This can be provided through instances of audio mixing modules 26a-26d. Additionally, each of these devices may include a processor that can execute software or an algorithm to perform synchronization activities, as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein (e.g., database, table, cache, key, etc.) should be construed as being encompassed within the broad term ‘memory element.’ Similarly, any of the potential processing elements, modules, and machines described in this Specification should be construed as being encompassed within the broad term ‘processor.’ Each of nodes 12, 14, 16, and 18 can also include suitable interfaces for receiving, transmitting, and/or otherwise communicating data or information in a network environment.

Note that with the example provided above, as well as numerous other examples provided herein, interaction may be described in terms of two or three components. However, this has been done for purposes of clarity and example only. In certain cases, it may be easier to describe one or more of the functionalities of a given set of flows by only referencing a limited number of components. It should be appreciated that system 10 (and its teachings) are readily scalable and can accommodate a large number of components, participants, rooms, endpoints, sites, etc., as well as more complicated/sophisticated arrangements and configurations. Accordingly, the examples provided should not limit the scope or inhibit the broad teachings of system 10 as potentially applied to a myriad of other architectures.

It is also important to note that the steps in the preceding flow diagrams illustrate only some of the possible conferencing scenarios and patterns that may be executed by, or within, system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 10 in that any suitable arrangements, chronologies, configurations, and timing mechanisms may be provided without departing from the teachings of the present disclosure.

For example, in some embodiments the audio and/or video signals can be generated and subsequently transmitted directly to the terminating node 18. In other instances, either the audio or the video is sent directly to note 18 to be synchronized with each other. In other instances, the timing of the mixing can be changed such that certain performers send their audio and/or video data directly to the final node 18, whereas other performers adhere to the serialization protocol discussed above. Other embodiments transmit each video signal to the other nodes so that each performer can be seen during the performance by the other performers. Note also that, although the previous discussions have focused on musical performances, system 10 can be used in any type of collaboration activity (e.g., in business scenarios where multiple individuals are presenting and precision in audio or video propagation is being sought for the session, or in translation activities, etc.). Moreover, although system 10 has been illustrated with reference to particular elements and operations that facilitate the communication process, these elements and operations may be replaced by any suitable architecture or process that achieves the intended functionality of system 10.

What is claimed is:

1. A method, comprising:
receiving a first audio signal and a first video signal from a first network element;
adding a second audio signal to the first audio signal to generate a combined audio signal, wherein a second video signal is combined with the first video signal to generate a combined video signal, wherein the first network element and the second network element reside in different geographic locations; and
transmitting the combined audio signal and the combined video signal to a next destination.

2. The method of claim 1, further comprising:
recording the combined audio signal and the combined video signal at the next destination.

3. The method of claim 1, further comprising:
transmitting the combined audio signal and the combined video signal to an audience location;
rendering the combined audio signal and the combined video signal at the audience location; and
transmitting audience audio signals and audience video signals to locations associated with the first network element and the second network element.

4. The method of claim 1, wherein the next destination is associated with a performer that generates a third audio signal to be added to the combined audio signal from the first network element and the second network element.

5. The method of claim 1, wherein a reference audio track is played by the second network element and is included in the combined audio signal.

6. The method of claim 1, wherein the combined audio signal reflects a synchronization of the first audio signal and the second audio signal, and wherein the combined audio signal is rendered to an end user that generated the second audio signal.

7. The method of claim 1 wherein the second network element detects a delay associated with the audio data and compensates for the delay in conjunction with generating the combined audio signal.

8. Logic encoded in one or more tangible media that includes code for execution and when executed by a processor operable to perform operations comprising:
receiving a first audio signal and a first video signal from a first network element;
adding a second audio signal to the first audio signal to generate a combined audio signal, wherein a second video signal is combined with the first video signal to generate a combined video signal, wherein the first network element and the second network element reside in different geographic locations; and
transmitting the combined audio signal and the combined video signal to a next destination.

9. The logic of claim 8, the operations further comprising:
recording the combined audio signal and the combined video signal at the next destination.

10. The logic of claim 8, the operations further comprising:
transmitting the combined audio signal and the combined video signal to an audience location;
rendering the combined audio signal and the combined video signal at the audience location; and
transmitting audience audio signals and audience video signals to locations associated with the first network element and the second network element.

11. The logic of claim 8, wherein the next destination is associated with a performer that generates a third audio signal to be added to the combined audio signal from the first network element and the second network element.

12. The logic of claim 8, wherein a reference audio track is played by the second network element and is included in the combined audio signal.

13. The logic of claim 8, wherein the combined audio signal reflects a synchronization of the first audio signal and the second audio signal, and wherein the combined audio signal is rendered to an end user that generated the second audio signal.

14. An apparatus, comprising:
a memory element configured to store data,
a processor operable to execute instructions associated with the data, and
an audio mixing module, the apparatus being configured to:
receive a first audio signal and a first video signal from a first network element;
add a second audio signal to the first audio signal to generate a combined audio signal, wherein a second video signal is combined with the first video signal to generate a combined video signal, wherein the first network element and the second network element reside in different geographic locations; and
transmit the combined audio signal and the combined video signal to a next destination.

15. The apparatus of claim 14, the apparatus being further configured to:
transmit the combined audio signal and the combined video signal to an audience location;
render the combined audio signal and the combined video signal at the audience location; and
transmit audience audio signals and audience video signals to locations associated with the first network element and the second network element.

16. The apparatus of claim 14, wherein the next destination is associated with a performer that generates a third audio signal to be added to the combined audio signal from the first network element and the second network element.

17. The apparatus of claim 14, wherein a reference audio track is played by the second network element and is included in the combined audio signal.

18. The apparatus of claim 14, wherein the combined audio signal reflects a synchronization of the first audio signal and the second audio signal, and wherein the combined audio signal is rendered to an end user that generated the second audio signal.

19. The apparatus of claim 14, further comprising:
a control unit configured to transmit feedback signals to the first network element and the second network element, and wherein the control unit manages secondary audio signals between the first network element and the second network element.

20. The apparatus of claim 14 wherein the second network element detects a delay associated with the audio data and compensates for the delay in conjunction with generating the combined audio signal.
